(19) United States
(12) Patent Application Publication
(10) Pub. No.: US 2017/0061389 A1
(43) Pub. Date: Mar. 2, 2017

(54) EFFICIENCY OF SCHEDULING OF A MEETING TIME

(71) Applicant: International Business Machines Corporation, Armonk, NY (US)

(72) Inventors: Danielle H. Naughton, Dublin (IE); Christopher J. Reckling, Chestnut Hill, MA (US); Sue Un, Centreville, VA (US)

(21) Appl. No.: 15/157,957

(22) Filed: May 18, 2016

Related U.S. Application Data
(63) Continuation of application No. 14/833,769, filed on Aug. 24, 2015.

(51) Int. Cl. G06Q 10/10

(52) U.S. Cl. CPC G06Q 10/1095

(57) ABSTRACT

In an approach to schedule a meeting, one or more computers receive a command to schedule a meeting. In the approach, one or more computers determine one or more invitees to the meeting and an availability of each of the one or more invitees. In addition, the approach includes the one or more computers receiving a user selection of one or more time intervals for the meeting to determine a first meeting duration, based on the user selection of the one or more time intervals. Furthermore, the approach includes determining by the one or more computers a first meeting time, based on the first meeting duration, and the availability of the one or more invitees.

### BACKGROUND OF THE INVENTION

The present invention relates generally to the field of online meeting scheduling and more particularly to user interfaces for online meeting scheduling.

In the global business environment, meetings commonly occur online or in teleconferences rather than traditional face-to-face meetings, especially when product teams, business partners, and customers have various geographic locations. Many employees and managers schedule and connect to meetings or teleconferences using mobile devices, in addition to using traditional desktop computers. Meetings may be scheduled or connected to while an employee is travelling, in another meeting, or at home, in addition to the traditional face-to-face meeting.

### SUMMARY

Embodiments of the present invention disclose a method, a computer program product, and a system to schedule a meeting. The method includes one or more computers receiving a command to schedule a meeting and determining one or more invitees to the meeting. The method includes the one or more computers determining an availability of each of the one or more invitees. In addition, the method includes the one or more computers receiving a user selection of one or more time intervals for the meeting and determining a first meeting duration, based on the user selection of the one or more time intervals. Furthermore, the method includes the one or more computers determining a first meeting time, based on the first meeting duration, and the availability of the one or more invitees.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a scheduler program, on a computer within the distributed data processing environment of FIG. 1, for determining a meeting duration, a meeting time, and invitee availability for scheduling a meeting, in accordance with an embodiment of the present invention;

FIG. 3 depicts an example of a user interface pane for a scheduler program, on a computing device within the distributed data processing environment of FIG. 1, for displaying information to schedule a meeting, in accordance with an embodiment of the present invention;

FIG. 4 depicts an example of a user interface pane for a meeting scheduler program, on a computing device within the distributed data processing environment of FIG. 1, for displaying additional methods of selecting information, in particular a meeting duration, for scheduling a meeting, in accordance with an embodiment of the present invention; and

FIG. 5 depicts a block diagram of components of a computer system, which is an example of a system such as the server within the distributed data processing environment of FIG. 1, in accordance with an embodiment of the present invention.

### DETAILED DESCRIPTION

Embodiments of the present invention recognize that programs and applications that enable improving efficiency of meeting scheduling provide individuals and corporations with an ability to save time when scheduling a meeting duration, an associated meeting day, and a meeting time of day. The time savings may be significant when applied over the number of meetings scheduled in a month or in a year.

Embodiments of the present invention provide a method for quickly and efficiently select a meeting duration, a meeting day, and a meeting time with minimal user input or with few user actions on user interfaces that can be simpler, more intuitive, and easier to operate than existing user interfaces. In addition, embodiments of the present invention use software algorithms to customize a meeting scheduler to provide options for meeting durations based on historical data of user selections and on an analysis of data on the actual duration or meeting length of previously scheduled meetings. Implementation of embodiments of the invention may take a variety of forms, and exemplary implementation details are discussed subsequently with reference to the Figures.

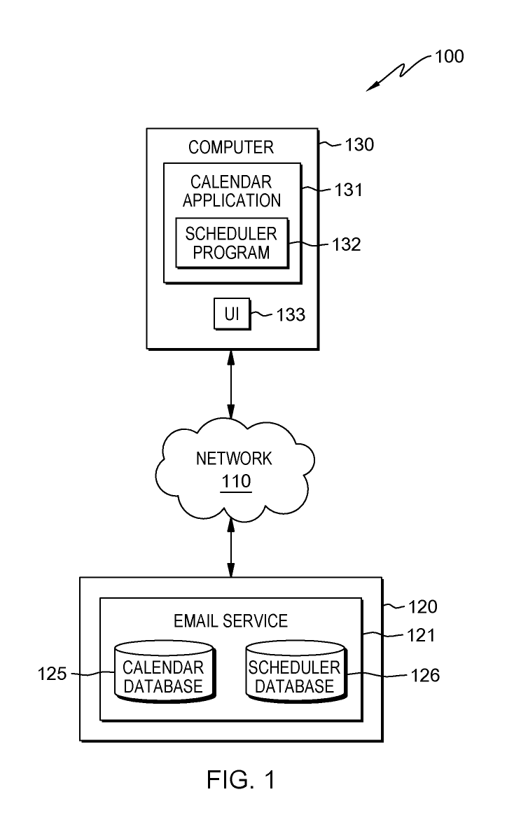

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server 120 and computer 130 interconnected over network 110. Network 110 can be, for example, a telecommunications network, a local area network (LAN), a virtual LAN (VLAN), a wide area network (WAN), such as the Internet, or a combination of these, and can include wired, wireless, virtual, or fiber optic connections. Network 110 can include one or more wired and/or wireless networks that are capable of receiving and transmitting data, voice, and/or video signals, including multimedia signals that include voice, data, and video information. In general, network 110 can be any combination of connections and protocols that will support communications between server 120, computer 130 and other computing devices (not shown) within distributed data processing environment 100.

Server 120 can be a web server, a management server, a standalone computing device, a database server, a mobile computing device, a laptop computer, a desktop computer, or any other electronic device or computing system capable of receiving, sending, storing, and processing data. In various embodiments, server 120 represents a computing system utilizing clustered computers and components (e.g., database server computers, application server computers, etc.) that act as a single pool of seamless resources, such as in a cloud computing environment, when accessed within distributed data processing environment 100. In various embodiments, each of the programs, applications, and databases on server 120 and computer 130 can reside on various other computing devices with distributed data processing environment 100, provided each has access to information and storage for implementation and operations of the present invention via network 110.

Server 120 hosts email service 121, which includes scheduler database 126, calendar database 125, and other applications or programs (not shown in FIG. 1) provided by an email messaging service such as those known in the art. Email service 121 provides the ability to send, receive, store, organize, and retrieve email, email history and email threads, which are the running list of all replies to an original or forwarded email, from a database (not shown in FIG. 1). In addition, email service 121 may include the ability to store, update, and retrieve contacts and user information such as userids from a database or other data storage location, provide calendar functions such as calendar updates and user availability from calendar database 125, provide meeting scheduling functions such as receiving, storing, and retrieve meeting duration and actual meeting lengths from scheduler database 126, and other email related functions as known to one skilled in the art. While depicted on server 120, email service 121 may reside on another server, another computing device, or other multiple computing devices. In another embodiment, the code and routines of scheduler program 132 reside in email service 121 on server 120.

Calendar database 125 receives, stores and retrieves calendar related information and data from email service 121, calendar application 131, and scheduler program 132 on computer 130, and from other computing devices (not shown in FIG. 1). Calendar database 125 receives, stores, and provides calendar information for one or more users scheduling a meeting or users who are meeting invitees. In various embodiments, scheduler program 132 retrieves information on invitee availability from calendar database 125. For example, calendar database 125 may provide information such as a user or an invitee availability for a date or a specified meeting time to scheduler program 132.

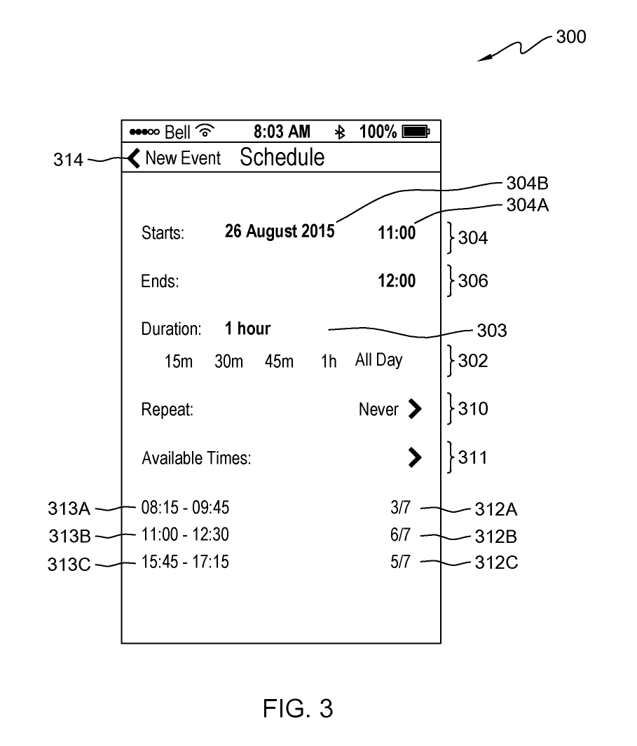

Scheduler database 126 on server 120 receives, retrieves, and stores data on meeting scheduling received from calendar application 131 and scheduler program 132 on computer 130, from email service 121 on server 120, and from calendar database on server 120. Scheduler database 126 receives from scheduler program 132 user selections of time intervals and meeting durations, which may be retrieved by scheduler program 132 for analysis of user preferences and customization of displayed time intervals and default meeting duration. Upon receiving from calendar application 131, a command to schedule a meeting time and a meeting day, scheduler program 132 displays to a user a user interface such as user interface (UI) 133, which in an embodiment is displayed as user interface pane 300, as depicted in FIG. 3, that displays options for selecting a meeting duration, a repeating meeting, a meeting date and a meeting time, in addition to displaying invitee availability for the selected meeting day or meeting date. Scheduler database 126 may provide to scheduler program 132 data on actual meeting length. While depicted on server 120, calendar database 125 and scheduler database 126 may reside on another computing device or on multiple computing devices (not depicted in FIG. 1). In various embodiments of the present invention, the information and data stored in calendar database 125 and scheduler database 126 may be stored in a single database, or on one or more databases located elsewhere in distributed data processing environment 100, accessible via network 110.

In various embodiments, computer 130 is a client to server 120. Computer 130 includes calendar application 131, scheduler program 132, and UI 133. Although not depicted in FIG. 1, computer 130 includes an email application that provides the ability for the user on computer 130 to send, receive, retrieve, and store emails including meeting notices and invitee contact information stored in another database (not depicted in FIG. 1) on server 120. In some embodiments, computer 130 may be a notebook, a laptop, a personal digital assistant, a tablet, a smart phone, a wearable computing device, or other computing system connected to server 120 via network 110. Computer 130 sends and receives data and information such as invitee availability, selected meeting duration, selected meeting date and meeting time, and actual meeting length to and from scheduler database 126 and calendar database 125 on server 120 via network 110. Computer 130 may send and receive data from other computing devices (not shown) in distributed data processing environment 100. While computer 130 is depicted as a single client device, computer 130 may be multiple computing devices or client devices used to communicate and exchange data with email service 121 and scheduler database 126 on server 120 via network 110.

Calendar application 131 on computer 130 receives user selection of invitees, retrieves invitee email addresses, creates, sends and receives meeting invitees, processes meeting acceptances/declines, coordinates meeting responses with calendar available times, and sends data on calendar availability to calendar database 125. In various embodiments, calendar application 131 is included in an email application (not depicted in FIG. 1) on computer 130. In some embodiments, calendar application 131 in the email application on computer 130 utilizes email service 121 on server 120. In the exemplary embodiment, scheduler program 132 is a program within calendar application 131. In an embodiment, the code and routines of scheduler program 132 are included in calendar application 131.

Scheduler program 132 is depicted in calendar application 131 on computer 130. In one embodiment, the code and routines of scheduler program 132 are a standalone program (e.g., are not included in calendar application 131). Scheduler program 132 receives user selections from UI 133 relative to scheduling a meeting. The user selections in scheduler program 132 may include a selection of one or more time intervals to determine a meeting duration, a meeting date, and a meeting time for a meeting. Scheduler program 132 may receive from calendar application 131 user selections of one or more meeting invitees and a meeting day. In various embodiment, scheduler program 132 schedules the meeting time automatically, based on a default meeting duration and the availability of the invitees on a selected day. Scheduler program 132 may receive one or more user selections of a time interval in a user interface pane such as user interface pane 300 to determine a meeting duration. The time intervals displayed to the user for selection to determine a meeting duration are initially pre-set as a default in scheduler program 132.

The time intervals displayed in scheduler program 132 are time intervals commonly used in selecting a meeting. In various embodiments, the number of time intervals displayed is limited. For example, the number of time intervals displayed may be three to ten time intervals. The number of time intervals displayed may be determined by the area available to display time intervals in UI 133 for scheduler program 132. Since the user may select commonly used time intervals more than once to determine a desired meeting duration, a large number of time intervals is not required to attain frequently scheduled meeting durations. In addition, in some embodiments, scheduler program 132 customizes meeting duration and time intervals based on an analysis of previous user selections of time intervals and meeting duration. In various embodiments, scheduler program 132 determines meeting times based, at least in part, on the meeting duration and invitee availability for the selected day. In an embodiment, scheduler program 132 determines the meeting time and meeting day based on the meeting duration and invitee availability. Scheduler program 132 retrieves from calendar database 125 invitee availability to determine potential meeting times with the most available meeting invitees. In an embodiment, scheduler program 132 retrieves invitee availability from database 135 on computer 130 when the user is off-line to determine invitee availability for potential meeting times. The method of invitee selection and retrieval of invitee information or contact information such as userids are not discussed in detail or included in embodiments of the present invention but, may be included in calendar application 131.

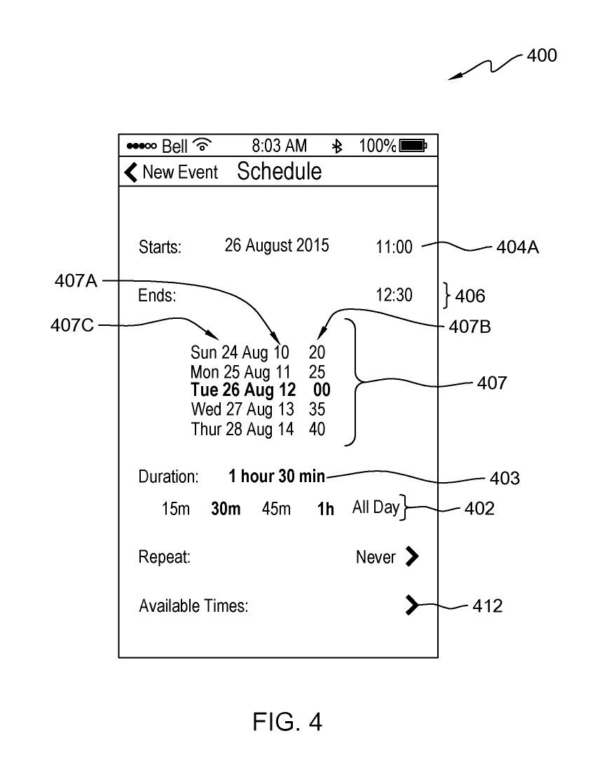

UI 133 on computer 130 is a user interface providing an interface between a user and computer 130, and enables a user of computer 130 to interact with programs and data on computer 130, server 120, and other computing devices (not shown in FIG. 1). UI 133 may be a graphical user interface (GUI), an active area or line for text inputs, a web user interface (WUI), or other type of user interface and can display text, documents, user options, application interfaces, and instructions for operation such as queries, and include the information that a program presents to a user. In an embodiment, UI 133 receives a user input via a touch screen, a key board, a mouse, a display, an audio or voice, visual or motion sensing device or other peripheral device standard in computer devices. UI 133 may be used by a user to receive and to display the user input in addition to displaying the output of scheduler program 132 (e.g., user interface pane 300 and 400 of FIGS. 3 and 4, respectively). UI 133 displays, for example, meeting time intervals, meeting duration, potential meeting dates, meeting frequency, invitee availability, and potential meeting times as determined by scheduler program 132.

Database 135 resides on computer 130. Database 135 receives and stores data on user selections of time intervals, meeting duration, and custom time intervals from scheduler program 132 in addition to other information on scheduling a meeting. Database 135 is capable of sending and receiving data such as meeting duration selections, selected time intervals, and information on invitee availability. In an embodiment, database 135 receives, from scheduler program 132 or calendar application 131, contact or invitee calendar information retrieved from calendar database 125 on server 120. Contact or invitee calendar information stored in database 135 may be retrieved by scheduler program 132 to determine a meeting time when the user is off-line.

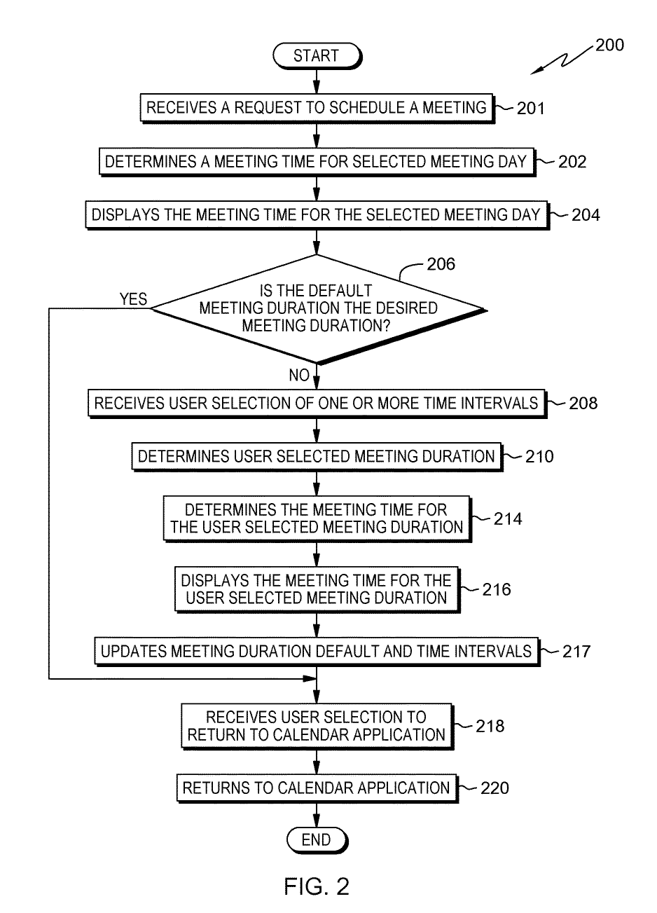

FIG. 2 is a flowchart depicting operational steps of scheduler program 132, on computer 130 within the distributed data processing environment 100 of FIG. 1, for determining a meeting duration, a meeting time, a meeting day, and invitee availability for scheduling a meeting, in accordance with an embodiment of the present invention. The operational steps of scheduler program 132 are discussed with reference to user interface pane 300 of FIG. 3 and user interface pane 400 of FIG. 4.

Scheduler program 132 receives a request to schedule a meeting (201). A user of calendar application 131 may send a request to scheduler program 132 to schedule meeting time based on user selections of the meeting invitees and meeting day provided by calendar application 131, and a default meeting duration in scheduler program 132, which may be changed or customized by the user. To initiate the command to scheduler program 132, the user in calendar application 131 may select a symbol such as an arrow for “more” in a line labelled “schedule”, a word such as “schedule”, an icon for “schedule”, an active area configured to initiate scheduler program 132, or another element identifying a selection or an initiation of scheduler program 132. The user in calendar application 131 may have opened the calendar for a specific day or date selected by the user that is initially used by scheduler program 132 to schedule a meeting time. If the user has not opened the calendar to a specific date or selected a meeting day in calendar application 131, then, scheduler program 132 determines the current day or today's date is the selected meeting day. Additionally, the user may have selected or entered in calendar application 131 the invitees used for scheduling a meeting time in scheduler program 132. Scheduler program 132 receives from calendar application 131 the invitees selected for the meeting.

Scheduler program 132 determines a meeting time for the selected meeting day (202). Scheduler program 132 initially determines the time for the meeting by evaluating the time with the most available invitees corresponding to a default meeting duration. In some embodiments, scheduler program 132 receives from the user a minimum or threshold number of available invitees that are desired for a meeting that is used in determining a meeting time. For example, the user may indicate at least 10 invitees are must be able to attend the meeting or may indicate that at least 70% of the invitees can attend during a selected meeting time. In one embodiment, scheduler program 132 receives an indication or an input from the user that a set number or percentage (e.g., 7, 80% or all) of the required attendees must be available for a selected meeting time. The default meeting duration is initially configured or pre-set in scheduler program 132. If invitees were not selected in calendar application 131 prior to requesting scheduler program 132 to determine a meeting time, then scheduler program 132 determines the meeting time according the user's availability (e.g., retrieves available times from the user's calendar information stored in calendar database 125). Based on the default meeting duration, invitee availability, and the selected day, scheduler program 132 determines the meeting time with the most available invitees for the selected day.

Scheduler program 132 retrieves invitee availability from calendar database 125 to determine the meeting time for the selected meeting day (e.g., depicted in date 304B in FIG. 3). A user may select new event 314 in user interface pane 300 to return to calendar application 131 to add or delete invitees. Scheduler program 132 analyzes the availability of the invitees and the default meeting duration to determine the meeting time that provides the meeting with the most available invitees for the selected day. The meeting time determined by scheduler program 132 displays as meeting start time (e.g., depicted in start time 304A in FIG. 3) and the meeting end time (e.g., depicted as ends 306) corresponding to the default meeting duration (e.g., depicted as duration 303 in FIG. 3).

In one embodiment, when the user is off-line, scheduler program 132 retrieves invitee calendar information stored in database 135 on computer 130. Computer 130 may store in database 135 the availability for the contacts or invitees whose contact information is stored in the user's contact information in calendar application 131 or the user's e-mail contact list in addition to storing the user's availability. Scheduler program 132 may periodically update information on contact or invitee availability, for example, every hour, by retrieving the contact availability from calendar database 125 and storing the information locally in database 135. In an embodiment, calendar application 131 updates contact calendar information.

Scheduler program 132 displays the meeting time for the selected meeting day (204). As depicted in FIG. 3, user interface pane 300 displays the determined meeting time in start time 304A and ends 306 for the selected meeting day depicted in date 304B. The meeting duration displayed in duration 303 is a default meeting duration, which in this case, for example, is an initially configured default meeting duration of one hour. In various embodiments, scheduler program 132 displays other potential meeting times for the selected day depicted as times 313A-C and the corresponding invitee availability as determined by the program for the other potential times depicted as availability 312A-C. From user interface pane 300, the user may at any time select another meeting time from the other potential meeting times displayed in times 313A-C by selecting (e.g., by touching or tapping) one of the potential meeting times.

Scheduler program 132 determines whether the default meeting duration is the desired meeting duration (decision 206). Based on the user selections in user interface pane 300, scheduler program 132 determines the default meeting duration is the desired meeting duration (yes branch, decision 206), when scheduler program 132 receives a user selection to return to calendar application 131 (218). Scheduler program 132 receives the user selection to return calendar application 131 when new event 314 is selected by touching the arrow or greater than sign for “more”, the words “New Event”, or the area between the arrow and the words “New Event” in user interface pane 300 in FIG. 3. When new event 314 is selected, scheduler program 132 determines the default meeting duration is the desired meeting duration. Scheduler program 132 saves and sends the default meeting duration, and any other user selections to scheduler database 126 and database 135. Scheduler program 132 returns to calendar application 131 (220). In calendar application 131, the user may choose to send meeting notices to the invitees, to update calendar application 131 options such as location, description, type of meeting (e.g., on-line or conference call), to update invitees and/or return to scheduler program 132.

However, scheduler program 132 determines the default duration is not the desired duration (no branch, decision 206), when the program receives a user selection of one or more time intervals (208). The user selects one or more time intervals in time intervals 302 displayed in user interface pane 300 for another meeting duration. Scheduler program 132 receives one or more user selections of time intervals 302.

In various embodiments, scheduler program 132 is configured to display commonly used time intervals used in meeting durations in time intervals 302 and custom meeting durations stored as time interval selections. For example, as depicted in FIG. 3, time intervals 302 display time intervals such as 15 minutes shown as 15 m, 30 minutes shown as 30 m, 45 minutes shown as 45 m, 1 hour shown as 1 h, and all day are presented to the user to select for a meeting duration. The time intervals displayed in time intervals 302 may be one of the following: pre-set as a default in scheduler program 132 or updated time intervals determined by scheduler program 132 based on an analysis of user preferences or previous user meeting duration selections.

In an embodiment, scheduler program 132 changes the pre-set or default displayed time intervals in time intervals 302 based on analysis of historical data of previous user selections of time interval selections. Scheduler program 132 retrieves from scheduler database 126 on server 120 the previous user selections of time intervals for a meeting duration. The user selection of a custom meeting duration may be stored in scheduler database 126 as a time interval selection and retrieved, in addition to user selections of displayed time intervals to determine the most frequently selected time intervals. The data on the user's previous or historical selection of various time intervals includes the user selection of another or one or more custom time intervals as input on picker 407, depicted in user interface pane 400 of FIG. 4, or input by another method of creating a custom time interval. Scheduler program 132 analyzes the retrieved historical data of user selections of various time intervals to determine the most frequently selected time intervals. In another embodiment, scheduler program 132 may determine time intervals for a meeting based on actual meeting duration of a plurality of user meetings. For example, scheduler program 132 may determine that the user and a first group of invitees typically meet for 20 minutes, whether a meeting is scheduled for 15 minutes or for 30 minutes. Scheduler program 132 may then include an option for 20 minute time interval when it determines the user is scheduling a meeting with the first group of invitees. In some embodiments, the actual meeting duration may be input by the user, or may be determined based on the user's computing device activity during an on-line meeting.

Scheduler program 132 determines the user selected meeting duration (210). In various embodiments, scheduler program 132 receives one or more user selections of the time intervals presented in time intervals 302. When more than one time interval is selected by a user, scheduler program 132 adds together the user selected time intervals to determine a meeting duration. For example, a user scheduling an hour and a half meeting on a smart phone (e.g., computer 130) may touch 1 h (i.e., one hour) and may touch 30 m (i.e., 30 minutes) on the touch screen to select an hour and a half meeting (i.e., 1 hour and 30 minutes). In an embodiment, scheduler program 132 executing on a computer device without a touch screen (e.g., a desktop or a notebook) uses a user interface device such as a mouse, a cursor, or an enter key to select one or more desired time intervals (e.g., select 1 h and 30 m in time intervals 302 for an hour and a half meeting). A user may touch or click on a time interval more than once in time intervals 302 to achieve a desired meeting duration. For example, scheduler program 132 receives a command to set the meeting duration to two hours when the user touches 1 h twice in time intervals 302. The meeting duration may be selected or changed at any time in user interface pane 300 in FIG. 3, in user interface pane 400 in FIG. 4, or in another similar display screen in scheduler program 132 that displays the time intervals for selection. Scheduler program 132 with a user selection method such as a touch on screen or a click of a mouse on one or more of the time intervals in time intervals 302 provides the user with an improved method of selecting a meeting duration.

Additionally, scheduler program 132 provides the user with the ability to select a custom meeting duration. Scheduler program 132 determines the custom meeting duration by a change in start time 304A (e.g., 11:00 in FIG. 3) or a change in the end time displayed as ends 306 (e.g., 12:00 in FIG. 3). The change in the start time or the change to the end time may be done using a known picker application such as the date picker application (e.g., picker 407) depicted in FIG. 4. As known to one skilled in the art, a date picker application such as picker 407 depicted in user interface pane 400 of FIG. 4, may be used to change to meeting start time and meeting end time. Scheduler program 132 accesses a data picker application such as picker 407 when the user selects or taps on any of the elements, arrows, or words in the area for start 304 or ends 306. Scheduler program 132, in response to the user selection, displays a user interface view such as user interface pane 400. The user may scroll through hours (e.g., hour 407A) and minutes (e.g., minute 407B) and select the desired start time (e.g., a desired hour in hour 407A and/or a desired minute in minute 407B) when picker 407 is initiated for a start time with the selection of start 304. Similarly, another end time may be selected in picker 407 when picker 407 is initiated with a selection of ends 306 in user interface pane 300 or ends 406 in user interface pane 400. In various embodiments, in picker 407, the user may select a new meeting start or end time by touching, tapping on a desired time, or by another input selection method. The change in either or both the meeting start time displayed in start time 304A or end time displayed in ends 306 results in a change in the meeting duration.

By changing the start time, a new custom meeting duration, for example, a ten minute meeting, may be selected by the user. Similarly, when a user selects ends 306, a new end time scheduler program 132 may determine a new or custom meeting duration for the user. Scheduler program 132 sends the selected custom meeting duration to scheduler database 126. If the custom meeting duration is not a pre-set time interval, then scheduler program 132 also saves the custom meeting duration (e.g., ten minutes) as a custom time interval, which is sent and stored in scheduler database 126 on server 120 for storage as a time interval selection for the user of computer 130. A user also may select a meeting duration that is not a custom meeting duration using the picker application in scheduler program 132. For example, a user may select a common meeting duration such as 30 minutes with the picker application in addition to selecting the 30 minute (e.g., 30 m) in time intervals 302.

In addition to creating a custom meeting duration on picker 407, the user may select, for example, a new meeting day by scrolling through the dates displayed in date selection 407C and selecting another meeting day. When a new day is selected, scheduler program 132 automatically determines a meeting time for the selected day based on the time with the most available invitees. In various embodiments, the user may select another meeting day, another meeting start time, or another meeting end time at any time from user interface pane 300 by selecting start 304, or ends 306, respectively for meeting start or meeting end time to initiate picker 407.

Scheduler program 132 determines one or more meeting times for the user selected meeting duration (214). Based on the new or custom meeting duration, invitee availability, and the selected day, scheduler program 132 determines the meeting time with the most available invitees for the selected day. Scheduler program 132 retrieves invitee availability from calendar database 125 to determine the meeting time for the updated meeting duration. Scheduler program 132 analyzes the availability of the invitees and the user selected meeting duration for the selected meeting day to determine the meeting start (e.g., depicted in start time 404A in FIG. 4) and meeting end times (e.g., depicted as ends 406 in FIG. 4) corresponding to the meeting duration (e.g., duration 403 in FIG. 4) that provide the meeting with the most available invitees. In addition, scheduler program 132 provides the user with the ability to exit user interface pane 400 and view the invitee availability details for the new meeting duration and potential meeting times by touching available time 412 depicted by the greater than or “more” sign or arrow to the right of the words “available times”.

In various embodiments, scheduler program 132 determines a meeting time when a majority, or all, of the invitees can attend, and determines one or more meeting times when a plurality, or only some, of the invitees can attend. In other embodiments, a user can provide a rank of invitees, with a high rank may indicate an invitee selected as a required invitee who must attend the meeting, and a low rank indicating the invitee is an optional invitee who may or may not attend the meeting. For example, calendar application 131 may allow a user to select required or optional invitees and provides the user selection of invitee rank or attendance status (e.g., required or optional). Scheduler program 132 can determine a meeting time including the most invitees with a higher rank, and a meeting time for the most invitees (regardless of rank).

Scheduler program 132 displays the meeting time for the user selected meeting duration (216). When the user selects available time 412 in FIG. 4, the user interface pane displayed in response appears similar to user interface pane 300 in FIG. 3, but with the potential meeting times updated and available invitees updated to reflect the new meeting duration. For example, for a new meeting duration of one hour and a half, duration 403 would display 1 hr 30 m. Scheduler program 132 updates duration 403, start time 404A, and ends 406 updated based on the new meeting duration selected by the user in step 208.

Scheduler program 132 updates meeting duration default and time intervals (217). Scheduler program 132 may customize the default meeting duration and the time intervals initially displayed in duration 303 and time intervals 302 for user selection. In various embodiments, scheduler program 132 analyzes a user's patterns for scheduling a meeting to present the most frequently selected time intervals in time intervals 302 and to use the most commonly selected meeting duration as the default for scheduling a meeting. Scheduler program 132 includes knowledge-based software algorithms that may be used with retrieved data of previous selections of meeting duration to analyze the frequency of various meeting duration selections.

Scheduler program 132 retrieves the historical data of a user's meeting duration selections from a database such as scheduler database 126 or from database 135 in computer 130. Scheduler program 132 analyzes the user's selections of a meeting duration retrieved from scheduler database 126 to determine the most frequently selected meeting duration or in other words, the meeting duration with the highest frequency of user selection. In various embodiments, when the most frequently used meeting duration from the analysis of the historical user meeting duration selections is not the same as the default meeting duration, scheduler program 132 changes the default meeting duration for the user of computer 130 to the most frequently selected meeting duration from the analysis of the user's historical meeting duration selections. For example, when an analysis of the historical data on the user's meeting duration selections determines that the user most commonly creates meetings with an hour and a half duration, then scheduler program 132 changes the default meeting duration to 1 h 30 m or one hour and thirty minutes. Scheduler program 132 determines the most frequently selected meeting duration by determining a meeting duration selected more often than other meeting durations.

Scheduler program 132 may retrieve historical data of the user's meeting duration selections based on one of the following: on a regularly scheduled time interval (e.g., retrieve once a month), by pre-set or configured number of scheduled meetings (e.g., retrieve every thirty meetings), or by a user command (e.g., by a user typing a command such as “retrieve historical user selected meeting duration for the last two months”). Scheduler program 132 analyzes retrieved historical data on user meeting duration selection that includes any user custom meeting duration selections in picker 407 to determine the commonly used meeting durations.

In an embodiment, scheduler program 132 determines the updated default meeting duration for initial display in duration 303 in user interface pane 300 or duration 403 in user interface pane 400 based on retrieved data on actual meeting durations. In this case, scheduler program 132 may retrieve from storage (e.g., persistent storage 508 in computer 130) or a database, such as scheduler database 126 on server 120 or database 135 on computer 130, the records of the how long each meeting was (i.e., actual meeting length). For online meetings or conference calls using computer 130, scheduler program 132 is configured to send a command to computer 130 to record or capture actual online or conference call meeting durations or actual meeting length for the online or teleconference meetings conducted on computer 130 via network 110. The actual meeting length recorded by computer 130 is sent to scheduler database 126 on server 120 for storage. A user may input actual meeting length on computer 130 and send the actual meeting length to scheduler database 126 in an embodiment. Scheduler program 132 may retrieve actual meeting durations on a pre-set time (e.g., once a week), by the number of meetings scheduled (e.g., every 50 meetings), or by user request (e.g., by a user command or a touch on an icon, a button, or a menu item). Upon analyzing the historical data of the actual meeting lengths, scheduler program 132 determines the most common actual meeting length for inclusion in duration displayed for example, in duration 303 in user interface pane 300 or duration 403 in user interface pane 400, as the updated default meeting duration.

Additionally, in various embodiments, scheduler program 132 retrieves from scheduler database 126 data on previous user selections of time intervals including custom time intervals and time interval 302 selections to analyze the frequency of the user selection of each time interval. Scheduler program 132 customizes the displayed time intervals in time intervals 302 for user selection based on the analysis of the most frequently user selected time intervals or the time intervals with the highest frequency of selection by the user. In the exemplary embodiment, when the six most frequently selected time intervals do not match the pre-set time intervals in the default time intervals (e.g., in time intervals 302 and/or time intervals 402), then scheduler program 132 replaces one or more of the pre-set time intervals (e.g., in time intervals 302 and/or time intervals 402). Scheduler program 132 displays the most frequently selected time intervals as the updated default time intervals (e.g., in time intervals 302). In another embodiment, the pre-set time intervals displayed in scheduler program 132 (e.g., in time intervals 302 and/or time intervals 402) include more than six pre-set intervals. For example, seven to ten pre-set time intervals may be updated with the corresponding number of most frequently selected time intervals. In this example, time intervals 302 may be pre-set with seven to ten time intervals. In an embodiment, the pre-set time intervals are less than six time intervals. For example, the pre-set time intervals as displayed in time intervals 302 may be three to five time intervals, which may be similarly updated with the corresponding number of most frequently selected time intervals based on the analysis of the user's historical time interval selections.

Scheduler program 132 receives user selection to return to calendar application (218). In various embodiments, the user selects new event 314 to return to calendar application 131. When the user selects new event 314, scheduler program 132 saves meeting duration, meeting time, selections of meeting frequency, meeting day and any other user selections regarding scheduling the meeting and sends the data to scheduler database 126. In response to receiving the user selection of “new event”, scheduler program returns to calendar application 131 where the user may select to send the meeting notices to the invitees or may continue, for example, to add invitees, meeting description, meeting location, or meeting type (e.g., conference call or on-line meeting). In various other embodiments, a user may select on UI 133 an option to send meeting invites or meeting notices from the user interface pane 300, user interface pane 400, or similar user interface display. In another embodiment, there may be an option displayed on UI 133 depicted as user interface pane 300 or user interface 400 to close the display, for example, when a user determines the displayed meeting times are not acceptable to the user and the user desires to postpone scheduling the meeting.

Additionally, at any time from user interface pane 300 or user interface pane 400, a user may select a meeting frequency for a repeating meeting by the “more” or greater than arrow in repeats 310, which initiates, for example, a pop-up selection for meeting repeat frequency (e.g., every day, every week, etc.). Scheduler program 132 provides a user viewing a display such as depicted by user interface pane 400 to request to review invitee details for meeting time for a selected day by selecting available time 412, which returns the user to a display such as user interface pane 300 with invitee availability depicted in availability 312A-C, for example. Additionally, from user interface pane 300, scheduler program 132 provides the user with the ability to view additional invitee availability details for potential meeting time by selecting or tapping on any of the fractions depicting the invitees availability for a potential time, or in other words, selecting any one of availability 312A-C. For example, when a user selects 312A depicted as 3/7 in FIG. 3, a list of invitees by name may include the invitee's userids, whether or not the invitee is a required invitee, or whether not the invitee is available or not for the potential meting time associated with the selected availability (e.g., availability 312A for times 313A) may be displayed.

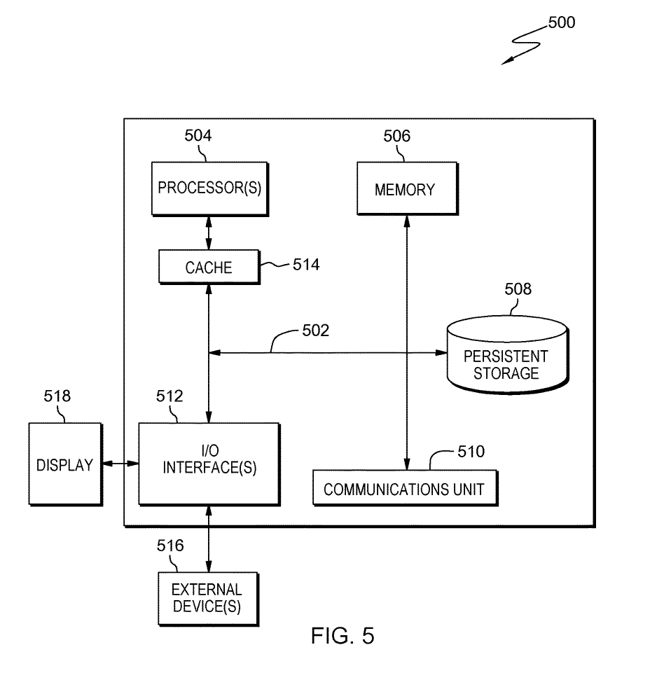

FIG. 5 depicts a block diagram 500 of components of a computer system, which is an example of a system such as computer 130 within distributed data processing environment 100, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

Computer 130 includes processor(s) 504, cache 514, memory 506, persistent storage 508, communications unit 510, input/output (I/O) interface(s) 512, and communications fabric 502. Communications fabric 502 provides communications between cache 514, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM). In general, memory 506 can include any suitable volatile or non-volatile computer readable storage media. Cache 514 is a fast memory that enhances the performance of processor(s) 504 by holding recently accessed data, and data near recently accessed data, from memory 506.

Program instructions and data used to practice embodiments of the present invention are stored in persistent storage 508 for execution and/or access by one or more of the respective processor(s) 504 via cache 514. In this embodiment, persistent storage 508 includes a magnetic hard disk drive. Alternatively, or in addition to a magnetic hard disk drive, persistent storage 508 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is part of persistent storage 508.

Communications unit 510, in these examples, provides for communications with other data processing systems or devices, including resources of server 120, computer 130, and other computing devices not shown in FIG. 1. In these examples, communications unit 510 includes one or more network interface cards. Communications unit 510 may provide communications with either or both physical and wireless communications links. Program instructions and data used to practice embodiments of the present invention may be downloaded to persistent storage 508 through communications unit 510.

I/O interface(s) 512 allows for input and output of data with other devices that may be connected to computer 130. For example, I/O interface(s) 512 may provide a connection to external device(s) 516 such as a keyboard, a keypad, a touch screen, a microphone, a digital camera, and/or some other suitable input device. External device(s) 516 can also include portable computer readable storage media, for example, devices such as thumb drives, portable optical or magnetic disks, and memory cards. Software and data used to practice embodiments of the present invention can be stored on such portable computer readable storage media and can be loaded onto persistent storage 508 via I/O interface(s) 512. I/O interface(s) 512 also connect to a display 518.

Display 518 provides a mechanism to display data to a user and may be, for example, a computer monitor. Display 518 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application, or technical improvement over technologies found in the marketplace, or to enable others of ordinary skill in the art to understand the embodiments disclosed herein.

What is claimed is:

1. A method for scheduling a meeting, the method comprising:
receiving, by one or more computers, a command to schedule a meeting;
determining, by one or more computers, one or more invitees to the meeting and an availability of each of the one or more invitees;
receiving, by one or more computers, a user selection of one or more time intervals for the meeting;
determining, by one or more computers, a first meeting duration, based on the user selection of the one or more time intervals; and
determining, by one or more computers, a first meeting time, based on the first meeting duration, and the availability of the one or more invitees.

2. The method of claim 1, wherein the first meeting time is determined, by one or more computers, based, at least in part, on a meeting time corresponding to a threshold number of available invitees, wherein the threshold number is set by the user.

3. The method of claim 1, further comprising:
receiving, by one or more computers, a user selection of one of: a start time, an end time, and a start time and an end time;
determining, by one or more computers, a second meeting duration based on one of: the start time to a displayed end time, a displayed start time to the end time, and the start time to the end time;
determining, by one or more computers, a second meeting time, based on the second meeting duration and an availability of each of the one or more invitees;
storing, by one or more computers, at least one of: the first meeting duration and the second meeting duration in a database; and
storing, by one or more computers, at least one of: the second meeting duration as a user selected another time interval in the database and the one or time intervals selected by the user.

4. The method of claim 3, further comprising:
determining, by one or more computers, a meeting time, based, at least in part, on a default meeting duration;
retrieving, by one or more computers, one or more previous selections of a plurality of meeting durations, wherein the one or more previous selections include at least one of the first meeting duration and the second meeting duration from the database;
determining, by one or more computers, based on the one or more previous selections of the plurality of meeting durations, a meeting duration with a highest frequency of selection;
determining, by one or more computers, whether the default meeting duration is the same as the meeting duration with the highest frequency of selection; and
responsive to determining that the default meeting duration is not the same as the meeting duration with the highest frequency of selection, replacing, by one or more computers, the default meeting duration with the meeting duration with the highest frequency of selection.

5. The method of claim 3, further comprising:
retrieving, by one or more computers, a plurality of user selections of the one or more time intervals and a plurality of the user selected another time intervals;
analyzing, by one or more computers, a frequency of each of the plurality of the user selections of the one or more time intervals and the plurality of the user selected another time intervals; and
determining, by one or more computers, one or more time intervals with a highest frequency of user selection for display.

6. The method of claim 1, further comprises:
displaying, by one or more computers, a plurality of potential meeting times;
displaying, by one or more computers, an invitee availability for the one or more invitees associated with each of the plurality of potential meeting times;
receiving, by one or more computers, a user selection of a potential meeting time; and
determining, by one or more computers, a meeting time of the plurality of potential meeting times based on the user selection of the potential meeting time.

7. The method of claim 6, further comprises:
receiving, by one or more computers, a user selection of an availability for the one or more invitees associated with a potential meeting time of the plurality of potential meeting times;
determining, by one or more computers, an availability of for each of the one or more invitees for the potential meeting time; and
displaying, by one or more computers, the availability of each of the one or more invitees.
